(19) United States
(12) Patent Application Publication
(10) Pub. No.: US 2009/0191039 A1
(43) Pub. Date: Jul. 30, 2009

(54) TRANSPORT ARM AND ASSEMBLY LINE USING THE SAME

(75) Inventors: PEI-CHIN KUO, Tu-Cheng (TW); JUEY-FONG CHANG, Tu-Cheng (TW); WEN-TAO WANG, Shenzhen City (CN); ZHI-GANG HU, Shenzhen City (CN); XUE-SHUN XING, Shenzhen City (CN); XIAO-LING YU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/211,056

(22) Filed: Sep. 15, 2008

(30) Foreign Application Priority Data
Jan. 29, 2008 (CN) 200810300250.1

(51) Int. Cl. B25J 18/04

(52) U.S. Cl. 414/744.2

(57) ABSTRACT

A transport arm of the present disclosure includes a pneumatic cylinder and an acting arm. The pneumatic cylinder includes a main body, a piston rod, a piston and a guiding pin. A chamber is defined in the main body. The piston rod is partially received in the chamber of the main body. The piston rod defines a guiding groove therein, and a section of the guiding groove is slanted relative to an axis of the piston rod. The piston is fixed to the piston rod and partitions the chamber of the main body into two chambers. The guiding pin is fixed to the main body, and an end of the guiding pin adjacent to the guiding groove of the piston rod moveably engages in the guiding groove. The acting arm is fixed to an end of the piston rod opposite to the piston.

### BACKGROUND

1. Technical Field

The present disclosure relates to transport arms, and more particularly to a transport arm for an assembly line.

2. Discussion of Related Art

A typical transport arm includes a lifting cylinder, a tray, a driving cylinder, a rack, a gear, a rotary member, and an acting arm fixed to the rotary member. The tray is fixed to a piston rod of the lifting cylinder. A shaft is formed on a central section of the tray. The gear is rotatably sleeved on the shaft. The rotary member is fixed to a surface of the gear away from the tray. The lifting cylinder can drive the tray, together with the gear, and the rotary member, to move upwards and downwards. The rack is driven by the driving cylinder, and engages with the gear. The driving cylinder drives the gear to rotate via the rack. Therefore, the rotary member rotates with the gear, thereby rotating the acting arm.

In order to make the acting arm rotate and move upwards and downwards, the transport arm includes many components, such as two cylinders, the gear, the rack, the tray, and the rotary member. Thus, the transport arm has a complex structure and a relatively high cost.

Therefore, a transport arm with a simpler structure and a lower cost is desired.

### SUMMARY

In one aspect, a transport arm of the present disclosure includes a pneumatic cylinder and an acting arm. The pneumatic cylinder includes a main body, a piston rod, a piston and a guiding pin. A chamber is defined in the main body. The piston rod is partially received in the chamber of the main body. The piston rod defines a guiding groove therein, and a section of the guiding groove is slanted relative to an axis of the piston rod. The piston is fixed to the piston rod and partitions the chamber of the main body into two chambers. The end of the piston rod opposite to the piston protrudes out of the chamber. The guiding pin is fixed to the main body, and an end of the guiding pin adjacent to the guiding groove of the piston rod moveably engages in the guiding groove. The acting arm is fixed to an end of the piston rod opposite to the piston.

In another aspect, an assembly line includes a machine, a transport device adjacent to the machine, and a transport arm. The transport arm is configured for conveying workpieces from the machine to the transport device. The transport arm includes a pneumatic cylinder and an acting arm. The pneumatic cylinder includes a main body, a piston rod, a piston and a guiding pin. A chamber is defined in the main body. The piston rod is partially received in the chamber of the main body. The piston rod defines a guiding groove slanted relative to a central axis of the piston rod. The piston is fixed to the piston rod and partitions the chamber of the main body into two chambers. The end of the piston rod opposite to the piston protrudes out of the chamber. The guiding pin is fixed to the main body, and an end of the guiding pin adjacent to the guiding groove of the piston rod moveably engages in the guiding groove. The acting arm is fixed to the end of the piston rod opposite to the piston.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present transport arm and assembly line using the same. Moreover, in the drawings, like reference numerals designate corresponding parts throughout the several views.

FIG. 1 is an isometric, schematic view of a transport arm in accordance with one embodiment of the present disclosure.

FIG. 2 is a cross-sectional, schematic view of a pneumatic cylinder of the transport arm in FIG. 1.

FIG. 3 is an isometric, schematic view of a piston rod of the pneumatic cylinder in FIG. 2.

FIG. 4 is an isometric, schematic view of an assembly line using the transport arm in FIG. 1.

FIG. 5 is a cross-sectional, schematic view of a transport arm in accordance with another embodiment of the present disclosure.

### DETAILED DESCRIPTION

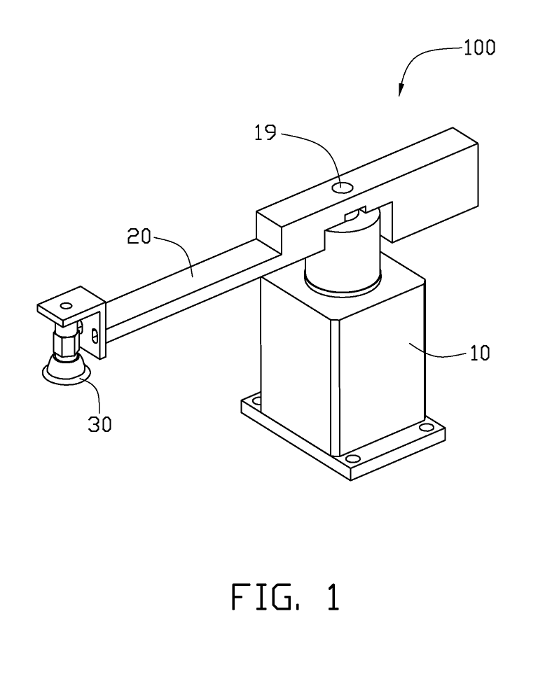

The present disclosure provides a transport arm and an assembly line using the same. Referring to FIG. 1, a transport arm 100 in accordance with one embodiment of the present disclosure is shown. In one embodiment, the transport arm 100 includes a pneumatic cylinder 10, an acting arm 20, and a pickup unit 30, such as a suction device. One end of the acting arm 20 defines a mounting hole (not labeled), and the other end opposite to the mounting hole is connected to the pickup unit 30. The pickup unit 30 is configured for picking up workpieces, such as a housing of an electronic device, or a bracket of a support device, for example.

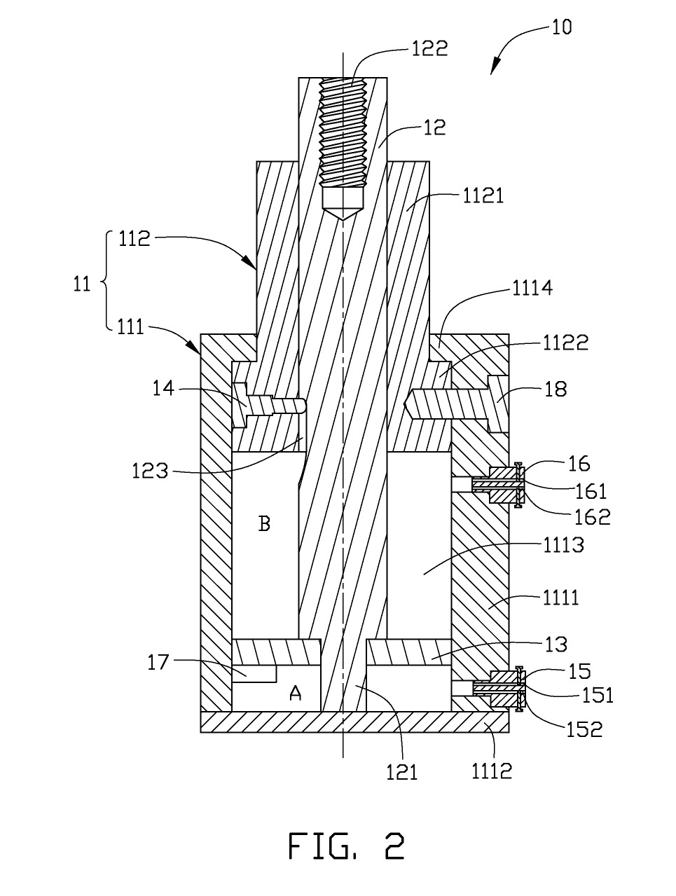

Referring to FIG. 2, the pneumatic cylinder 10 includes a main body 11, a piston rod 12, a piston 13, a guiding pin 14, a first gas valve 15, a second gas valve 16, a sensor 17, and a controller (not shown).

The main body 11 includes a main section 111 and a guiding sleeve 112. The main section 111 is shaped substantially as a cuboidal housing. The main section 111 includes a sidewall 1111, a bottom wall 1112 connected to one end of the sidewall 1111, and a top wall 1114 connected to another end of the side wall 1111 opposite to the bottom wall 1112. The sidewall 1111, the bottom wall 1112, and top wall 1114 cooperatively define a chamber 1113. The top wall 1114 defines an opening (not labeled) communicating with the chamber 1113.

The guiding sleeve 112 includes a first sleeve section 1121 and a second sleeve section 1122 connected to one end of the first sleeve section 1121. The first sleeve section 1121 and the second sleeve section 1122 are cylindrically shaped and elongated along a vertical axis, and the diameter of the second sleeve section 1122 is larger than that of the first sleeve section 1121. The second sleeve section 1122 of the guiding sleeve 112 is received in the chamber 1113 of the main section 111, and abuts the top wall 1114 of the main section 111. The first sleeve section 1121 protrudes out of the opening of the main section 111. The second sleeve section 1122 is fixed to the sidewall 1111 of the main section 111 by a screw 18. The second sleeve section 1122 defines a receiving hole (not labeled) corresponding to the guiding pin 14.

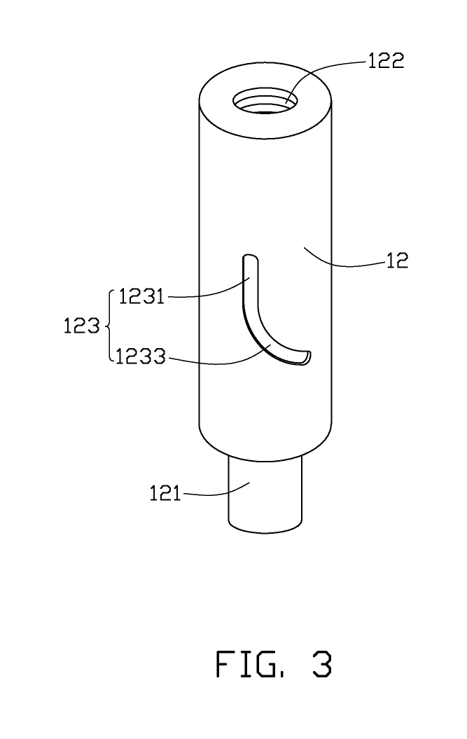

Referring also to FIG. 3, the piston rod 12 is cylindrically shaped and elongated along a vertical axis. The piston rod 12 includes a post 121 extending from one end along a cylindrical axis of the piston rod 12, and defines a threaded hole 122 in the other end opposite to the post 121. The piston rod 12 is passed through the guiding sleeve 112, and abuts the bottom wall 1112 of the main section 111. Therefore, the piston rod 12 is partially received in the chamber 1113 of the main body. The transport arm 100 further includes a bolt 19. The bolt 19 engages in the mounting hole of the acting arm 20 and the threaded hole 122 of the piston rod 12, so that the acting arm 20 is fixed to the piston rod 12. A cylindrical outer surface of the piston rod 12 defines a guiding groove 123. The guiding groove 123 includes a linear section 1231 and a curved section 1233 communicating with the linear section 1231. An extending direction of the linear section 1231 is parallel to a cylindrical axis of the piston rod 12. An extending direction of the curved section 1233 is slanted relative to the axis of the piston rod 12.

The piston 13 is received in the chamber 1113 of the main section 111, and fixed to the post 121 of the piston rod 12. The piston 13 is at a predetermined distance from the bottom wall 1112 of the main body 11. Thus, the chamber 1113 is partitioned into a first chamber A and a second chamber B. The piston 13 is configured for preventing gas from flowing freely between the first chamber A and the second chamber B.

The guiding pin 14 is passed through the receiving hole of the second sleeve section 1122. An end of the guiding pin 14 adjacent to the guiding groove 123 moveably engages in the guiding groove 123. Thus, the second sleeve section 1122, together with the guiding pin 14, is capable of moving along the guiding groove 123.

The first gas valve 15 and the second gas valve 16 are attached to the sidewall 1111 of main section 111, and communicate with the first chamber A and the second chamber B respectively. The first gas valve 15 defines an inlet channel 151 and an outlet channel 152. The inlet channel 151 communicates with a gas source (not shown). The second gas valve 16 defines an inlet channel 161 and an outlet channel 162. The inlet channel 161 communicates with the gas source.

In one embodiment, the sensor 17 may be a displacement sensor, and attached to a bottom surface of the piston 13. The controller is configured for controlling the pickup unit 30, the first gas valve 15, the second gas valve 16 and the sensor 17.

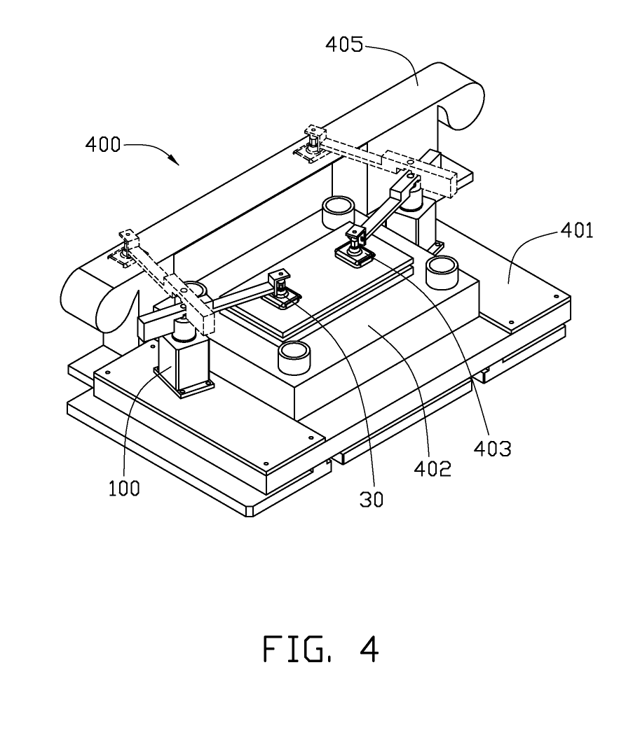

Referring also to FIG. 4, the transport arm 100 is illustrated in an assembly line 400. The assembly line 400 includes a machine 401, a transport device 405 adjacent to the machine 401, two transport arms 100 disposed on opposite sides of the machine 401. The transport device 405 is configured for transporting workpieces 403 to a next assembly process after the machine 401. A punch die 402 is installed on the machine 401, and configured for punching the workpieces 403. The workpieces 403 are placed on the punch die 402 by the transport arm 100.

At rest, the acting arm 20 is positioned above the punch die 402. When the workpieces 403 need to be moved to the transport device 405 after being punched by the punch die 402, the controller of the transport arm 100 controls the pickup unit 30 to pickup the workpiece 403. The controller further controls the inlet channel 151 of the first gas valve 15 and the outlet channel 162 of the second gas valve 16 to open. Then, gas from the gas source is injected into the first chamber A of the main body 11 via the inlet channel 151. An air pressure of the first chamber A is increased, thereby pushing the piston 13 and the piston rod 12 to move upwards. Air in the second chamber B flows out of the second chamber B via the outlet channel 162. At this time, the guiding pin 14 slides along the linear section 1231 of the piston rod 12 relative to the piston rod 12. The acting arm 20, together with the piston rod 12, non-rotatably move upwards. Therefore, the workpiece 403 is linearly lifted away from the punch die 402.

When the piston rod 12 further moves upwards, the guiding pin 14 slides into the curved section 1233 of the piston rod 12 relative to the piston rod 12. The guiding pin 14 applies a force to the sidewall in the curved section 1233, thus rotating the piston rod 12. When the guiding pin 14 slides to an end of the curved section 1233, the piston rod 12 stops rotating and moving upwards. The workpiece 403 may be then positioned directly above the transport device 405. The sensor 17 detects the stop of the piston rod 12, and creates a signal to the controller. The controller receives the signal and controls the pickup unit 30 to release the workpiece 403, so that the workpiece 403 is placed on the transport device 405. The transport device 405 can transport the workpiece 403 to a next working procedure.

Then, the controller controls the inlet channel 161 of the second gas valve 16 the outlet channel 152 of the first gas valve 15 to open, and controls the inlet channel 151 of the first gas valve 15 and the outlet channel 162 of the second gas valve 16 to close. Gas from the gas source is injected into the second chamber B via the inlet channel 161. An air pressure of the second chamber B is gradually increased, thereby pushing the piston 13 and the piston rod 12 to move downwards. The piston rod 12 rotatably moves downwards until a bottom surface of the piston rod 12 abuts the bottom wall 1112 of the main section 111. At this time, the acting arm 20 returns above the punch die 402. The sensor 17 detects the stop of the piston rod 12, and sends a signal to the controller. The controller controls the inlet channel 151 of the first gas valve 15 and the outlet channel 162 of the second gas valve 16 to open, and controls the outlet channel 152 of the first gas valve 15 and the inlet channel 161 of the second gas valve 16 to close. Then, the transport arm 100 repeats the action described above.

In this embodiment, the guiding pin 14 engages with the guiding groove 123 of the piston rod 12, which enables the acting arm 20 to move upwards and downwards and rotates. Thus, the transport arm 100 has a simpler structure and a lower cost.

In alternative embodiments, one of the first gas valve 15 and the second gas valve 16 may be omitted. In such cases, gas is injected into or pumped out of one of the first chamber A and the second chamber B. The guiding groove 123 may be a curved groove. An extending direction of the curved groove is slanted relative to the central axis of the piston rod 12. The guiding groove 123 may also be a linear groove. An acute angle is defined between an extending direction of the linear groove 123 and the central axis of the piston rod 12. It should be understood that a section of the guiding groove 123 should be slanted relative to a central axis of the piston rod 12.

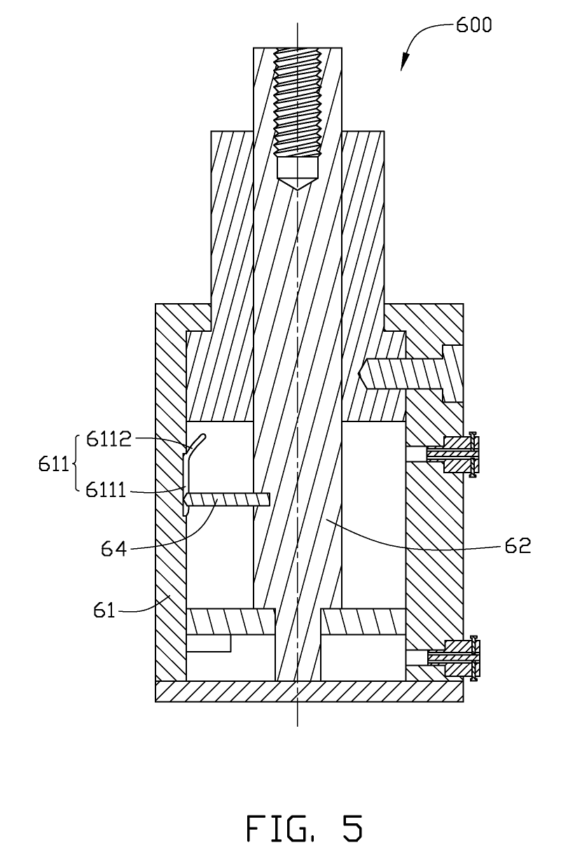

Referring to FIG. 5, a transport arm 600 in accordance with another embodiment of the present disclosure is shown. The transport arm 600 is similar to the transport arm 100 except that a guiding groove 611 is defined in an inner surface of a main body 61 instead of being defined in a piston rod 62, an end of a guiding pin 64 adjacent to the guiding groove 611 moveably engages into the guiding groove 611, and the opposite end of the guiding pin 64 is fixed to the piston rod 62. The guiding groove 611 is similar to the guiding groove 123 of the transport arm 100, and includes a linear section 6111 and a curved section 6112. An extending direction of the linear section 6111 is parallel to a central axis of the piston rod 62. An extending direction of the curved section 6112 is slanted relative to the central axis of the piston rod 62. The transport arm 600 is also capable of conveying a workpiece.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A transport arm, comprising:
a pneumatic cylinder including
a main body contoured as to define a chamber inside the body;
a piston rod partially received in the chamber of the main body, the piston rod defining a guiding groove therein, wherein a section of the guiding groove is slanted relative to a central axis of the piston rod;
a piston fixed to the piston rod and partitioning the chamber of the main body into two chambers, wherein an end of the piston rod opposite to the piston protrudes out of the chamber; and
a guiding pin fixed to the main body, wherein an end of the guiding pin adjacent to the guiding groove of the piston rod moveably engages in the guiding groove; and
an acting arm fixed to the end of the piston rod opposite to the piston.

2. The transport arm as claimed in claim 1, wherein the guiding groove includes a linear section and a curved section communicating with the linear section, wherein an extending direction of the linear section is parallel to the central axis of the piston rod, and wherein an extending direction of the curved section is slanted relative to the central axis of the piston rod.

3. The transport arm as claimed in claim 1, wherein a pickup unit is connected to the end of the acting arm away from piston rod, wherein the pickup unit is configured for picking up workpieces.

4. The transport arm as claimed in claim 1, wherein the pneumatic cylinder includes a plurality of gas valves communicating with the chamber, wherein the gas valves are configured for adjusting an air pressure of the pneumatic cylinder.

5. The transport arm as claimed in claim 4, wherein a number of the gas valves is two, the two gas valves communicates with the two chambers of the main body respectively.

6. The transport arm as claimed in claim 5, wherein each of the gas valves defines an inlet channel and an outlet channel, the inlet channel communicates with a gas source.

7. The transport arm as claimed in claim 4, wherein the pneumatic cylinder further comprises a displacement sensor attached to the piston.

8. A transport arm, comprising:
a pneumatic cylinder including
a main body contoured so as to define a chamber and a guiding groove;
a piston rod partially received in the chamber of the main body, wherein a section of the guiding groove of the main body is slanted relative to an axis of the piston rod;
a piston fixed to the piston rod and partitioning the chamber of the main body into two chambers, wherein an end of the piston rod opposite to the piston protrudes out of the chamber; and
a guiding pin fixed to the piston rod, wherein an end of the guiding pin adjacent to the main body moveably engages in the guiding groove; and
an acting arm fixed to the end of the piston rod opposite to the piston.

9. The transport arm as claimed in claim 8, wherein the guiding groove includes a linear section and a curved section communicating with the linear section, an extending direction of the linear section is parallel to the central axis of the piston rod, an extending direction of the curved section is slanted relative to the central axis of the piston rod.

10. An assembly line, comprising:
a machine;
a transport device adjacent to the machine; and
at least one transport arm configured for conveying workpieces from the machine to the transport device, each of the at least one transport arms comprising:
a pneumatic cylinder including
a main body contoured so as to define a chamber;
a piston rod partially received in the chamber of the main body, the piston rod defining a guiding groove therein, wherein a section of the guiding groove is slanted relative to a central axis of the piston rod;
a piston fixed to the piston rod and partitioning the chamber of the main body into two chambers, wherein an end of the piston rod opposite to the piston protrudes out of the chamber; and
a guiding pin fixed to the main body, wherein an end of the guiding pin adjacent to the guiding groove of the piston rod moveably engages in the guiding groove; and
an acting arm fixed to the end of the piston rod opposite to the piston.

11. The assembly line as claimed in claim 10, wherein a punch die is installed on the machine, and configured for punching the workpieces.

12. The assembly line as claimed in claim 10, wherein the guiding groove includes a linear section and a curved section communicating with the linear section, wherein an extending direction of the linear section is parallel to the central axis of the piston rod, and an extending direction of the curved section is slanted relative to the central axis of the piston rod.

13. The assembly line as claimed in claim 10, wherein a pickup unit is connected to the end of the acting arm away from piston rod, wherein the pickup unit is configured for picking up the workpieces.

14. The assembly line as claimed in claim 10, wherein the pneumatic cylinder includes a plurality of gas valves, each of the plurality of gas valves configured for adjusting an air pressure of the pneumatic cylinder.

15. The assembly line as claimed in claim 14, wherein a number of the gas valves is two, the two gas valves communicate with the two chambers of the main body respectively.

16. The assembly line as claimed in claim 15, wherein each gas valve includes an inlet channel and an outlet channel, the inlet channel communicates with a gas source.
